(19) United States
(12) Patent Application Publication
(10) Pub. No.: US 2017/0131406 A1
(43) Pub. Date: May 11, 2017

(54) Differential Positioning Method Based on Intelligent Vehicle Infrastructure Cooperative System and Intelligent Vehicle Infrastructure Cooperative System

(71) Applicant: Leauto Intelligent Technology (BEIJING) Co. Ltd, Beijing (CN)

(72) Inventors: Wenrui Li, Beijing (CN); Yong XU, Beijing (CN); Yu Zou, Beijing (CN); Kunsheng Chen, Beijing (CN); Wei Lin, Beijing (CN); Peng Liu, Beijing (CN); Dan Li, Beijing (CN)

(73) Assignee: Leauto Intelligent Technology (BEIJING) Co. Ltd, Beijing (CN)

(21) Appl. No.: 14/966,686

(22) Filed: Dec. 11, 2015

(30) Foreign Application Priority Data
Nov. 5, 2015 (CN) 201510745519.7

(51) Int. Cl. G01S 19/07; H04W 4/00; H04L 29/08; G01C 21/20; G01S 19/11

(52) U.S. Cl. CPC G01S 19/07; G01C 21/20; G01S 19/11; H04L 67/12; H04W 4/008

(57) ABSTRACT

The present disclosure provides a differential positioning method based on an intelligent vehicle infrastructure cooperative system and the intelligent vehicle infrastructure cooperative system. The system includes: a road side unit for obtaining a differential positioning correction parameter and broadcasting the differential positioning correction parameter to an on board unit within a preset range; and the on board unit for obtaining original positioning data of the on board unit, and correcting the original positioning data based on the differential positioning correction parameter to obtain final positioning data of the on board unit.

### FIELD OF TECHNOLOGY

Embodiments of the present disclosure relate to the technical field of intelligent traffic, and in particular, to an intelligent vehicle infrastructure cooperative system and a differential positioning method based on the intelligent vehicle infrastructure cooperative system.

### BACKGROUND

With the development of vehicle driving automation, precise positioning of vehicles has gradually become an important technology for achieving auxiliary driving and automatic driving. In existing satellite positioning systems, such as the US GPS (Global Positioning System), the Russian GLONASS (Glonass satellite navigation system), the Chinese Beidou system and the like, although they may provide positioning with a centimeter-level accuracy, they are not available for civilian use, and the positioning accuracy of a real civilian positioning system is about over ten meters or even tens of meters, and this accuracy is far below the requirements of auxiliary driving and automatic driving of vehicles. In order to achieve smaller positioning accuracy, differential positioning emerges at the right moment.

Differential positioning is also called differential GPS technology, namely, a GPS receiver is disposed on a base station for observation. According to a known precise coordinate of the base station, a distance correction number from the base station to a satellite is calculated, and the base station sends the data in real time. When carrying out GPS observation, a user receiver also receives the correction number sent by the base station and corrects a positioning result thereof, so as to eliminate the influence of a satellite clock error, a receiver clock error and atmospheric ionospheric and tropospheric refraction errors and improve the positioning accuracy, and the positioning accuracy corrected by differential positioning may reach a sub-meter level.

In the existing differential positioning methods, base stations need to be deployed to serve as corrected basic information providers, and communication data between the base stations and terminal devices are generally transmitted to the terminal devices through the Internet or a mobile operator network. Therefore, related network access devices are needed on both the base stations and terminals, the network state cannot be guaranteed, and the traffic fee of a mobile operator is also a burden. Meanwhile, the general working ranges provided by the existing differential base stations are generally 40-50 km, which is quite broad, therefore the correction result will be influenced, and if expecting to improve the accuracy, the number of the base stations needs to be increased and the interval range needs to be decreased, resulting in a larger engineering quantity.

### SUMMARY

Embodiments of the present disclosure provide a differential positioning method based on an intelligent vehicle infrastructure cooperative system and the intelligent vehicle infrastructure cooperative system, to solve the problems that a base station needs to be deployed in differential positioning in the prior art to cause a large engineering quantity, an unstable network state, a high traffic cost, positioning inaccuracy, etc.

An embodiment of the present disclosure provides an intelligent vehicle infrastructure cooperative system, including:

a road side unit for obtaining a differential positioning correction parameter and broadcasting the differential positioning correction parameter to an on board unit within a preset range; and

the on board unit for obtaining original positioning data of the on board unit, and correcting the original positioning data based on the differential positioning correction parameter to obtain final positioning data of the on board unit.

An embodiment of the present disclosure further provides a differential positioning method based on an intelligent vehicle infrastructure cooperative system, the intelligent vehicle infrastructure cooperative system including a road side unit and an on board unit, the method including:

obtaining a differential positioning correction parameter on the road side unit, and broadcasting the differential positioning correction parameter to the on board unit within a preset range; and

obtaining original positioning data of the on board unit on the on board unit, and correcting the original positioning data based on the differential positioning correction parameter to obtain final positioning data of the on board unit.

According to the differential positioning method based on the intelligent vehicle infrastructure cooperative system and the intelligent vehicle infrastructure cooperative system provided by the embodiments of the present disclosure, the road side unit in the vehicle infrastructure cooperative system is used as a base station to play the role of an application service provider, the on board unit is used as an mobile terminal to play the role of an application service user, DSRC in vehicle infrastructure cooperation is used as a communication technology, the road side unit is used for obtaining the differential positioning correction parameter and sending the differential positioning correction parameter to the on board unit, and the on board unit is used for correcting the original positioning data according to the differential positioning correction parameter to obtain the final positioning data of the on board unit, so as to achieve a differential positioning function in the vehicle infrastructure cooperative system, no additional base station needs to be deployed, no additional network access device needs to be added, a mobile operator or the Internet is not utilized, the stability of the network state is guaranteed, and the device cost and the traffic cost are saved.

In addition, as the maximal communication distance between the road side unit and the on board unit is 300-1000 m, which is much smaller than the working range (40-50 km) of a traditional differential base station, the differential positioning accuracy of the embodiments of the present disclosure is much higher than that of traditional methods, and the positioning accuracy corrected by the on board unit may reach a sub-meter level or even a centimeter level.

### BRIEF DESCRIPTION OF THE DRAWINGS

To illustrate technical solutions in the embodiments of the present disclosure or in the prior art more clearly, a brief introduction to the accompanying drawings which are needed in the description of the embodiments or the prior art is given below. Apparently, the accompanying drawings in the description below are merely some of the embodiments of the present disclosure, and other drawings may be obtained based on these drawings by those of ordinary skill in the art without any creative effort.

FIG. 1 is a structure block diagram of an intelligent vehicle infrastructure cooperative system embodiment in an embodiment of the present disclosure;

FIG. 2 is a structure block diagram of a road side unit embodiment in an embodiment of the present disclosure;

FIG. 3 is a step flowchart of an embodiment of a differential positioning method based on an intelligent vehicle infrastructure cooperative system in an embodiment of the present disclosure.

### DESCRIPTION OF THE EMBODIMENTS

In order that the objectives, technical solutions and advantages of the present disclosure are clearer, a clear and complete description of technical solutions in the embodiments of the present disclosure will be given below, in conjunction with the accompanying drawings in the embodiments of the present disclosure. Apparently, the embodiments described below are merely a part, but not all, of the embodiments of the present disclosure. All other embodiments obtained by those of ordinary skill in the art based on the embodiments of the present disclosure without any creative effort fall into the protection scope of the present disclosure.

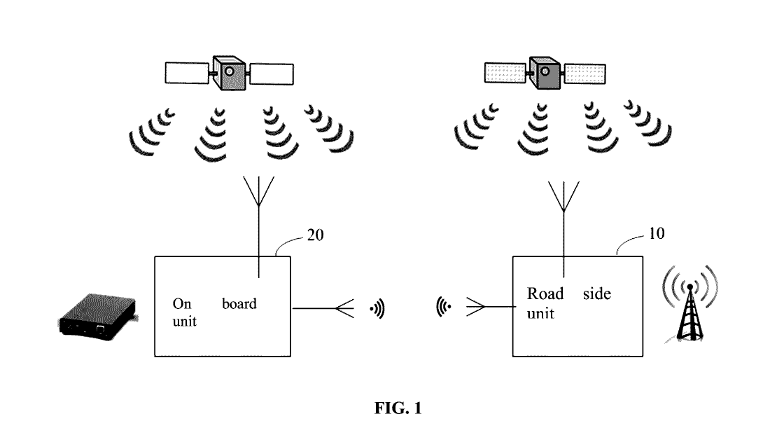

Referring to FIG. 1, it shows a structure block diagram of an intelligent vehicle infrastructure cooperative system embodiment in an embodiment of the present disclosure.

The intelligent vehicle infrastructure cooperative system (abbreviated as IVICS, vehicle infrastructure cooperative system in short), is the newest development direction of an intelligent traffic system (abbreviated as ITS). Vehicle infrastructure cooperation adopts advanced wireless communication, new generation Internet and other technologies to achieve vehicle-vehicle and vehicle-road dynamic real-time information interaction all around and carry out active vehicle safety control and road cooperation management on the basis of overall temporal and spatial dynamic traffic information collection and fusion, so as to fully achieve effective cooperation of human, vehicles and roads, guarantee traffic safety and improve the traffic efficiency, and a safe, efficient and environment-friendly road traffic system is formed accordingly.

As shown in FIG. 1, the intelligent vehicle infrastructure cooperative system in the embodiment of the present disclosure may include a road side unit 10 (abbreviated as RSU) and an on board unit 20 (abbreviated as OBU), wherein

the on board unit 20 is an on board positioning device, which is mounted in a travelling vehicle; the road side unit 10 refers to a communication and computer device mounted beside a lane or above the lane, with the function of achieving real-time high-speed communication with the on board unit 20 to carry out automatic vehicle identification, special target detection and image capture, etc.

In specific implementation, since the road side unit 10 is a device which is fixedly mounted on the road side, the position thereof is generally not changed, while the on board unit 20 is mounted in the travelling vehicle, so the position thereof is often changed, moreover, the communication between the road side unit 10 and the on board unit 20 is V2I (vehicle-to-infrastructure) communication, within a V2I communication range (300-1000 m in general), such influencing factors as a satellite orbit error, an atmospheric delay error, a satellite clock error, a receiver clock error, a multipath error, an SA (frequent shake of a satellite clock, a manually introduced ephemeris error or the like) and the like may be considered as being completely consistent, and thus it may be considered that the RSU and the OBU have common errors. Based on this, in the embodiment of the present disclosure, the road side unit 10 may be used as a base station for calculating a differential positioning correction parameter and broadcasting the differential positioning correction parameter to the on board unit 20 within a preset range; and the on board unit 20 is used as a terminal device for obtaining original positioning data of the on board unit 20, and correcting the original positioning data based on the differential positioning correction parameter to obtain final positioning data of the on board unit 20, so that the intelligent vehicle infrastructure cooperative system in the embodiment of the present disclosure may achieve a differential positioning function.

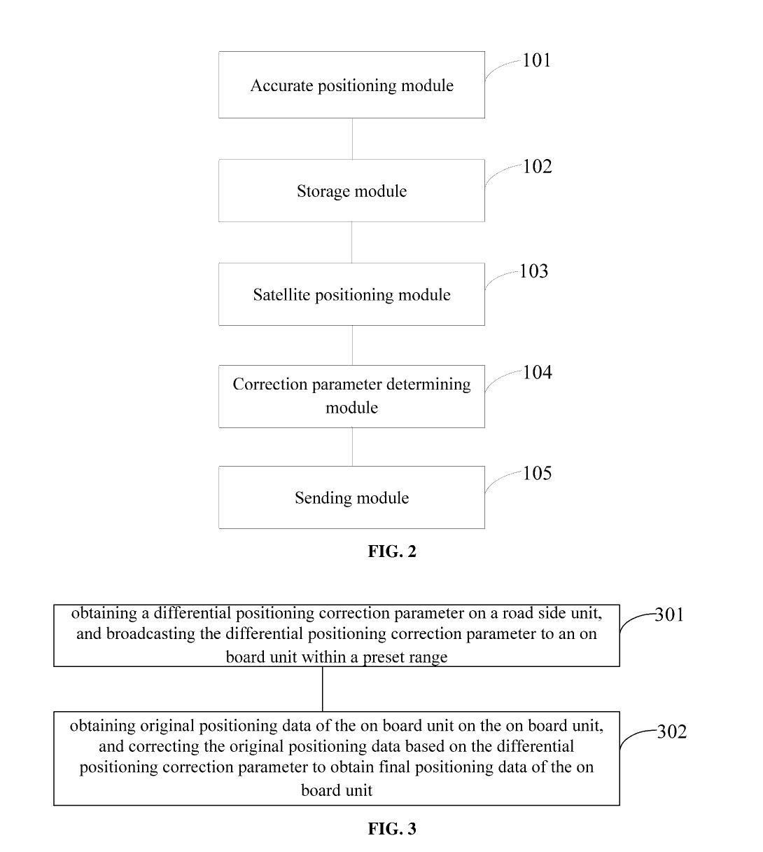

Specifically, referring to the structure block diagram of a road side unit embodiment in the embodiment of the present disclosure as shown in FIG. 2, in a preferred embodiment of the embodiment of the present disclosure, the road side unit 10 may include the following modules:

an accurate positioning module 101 for obtaining accurate positioning data of the road side unit 10; and

specifically, since the road side unit 10 is a device with a fixed position, the accurate positioning data of the road side unit 10 may be obtained, the accurate positioning data are positioning data having no error in theory, and may include longitude, dimensionality, altitude and other accurate positioning information of the road side unit 10.

In specific implementation, the accurate positioning module 101 may be used for measuring the accurate positioning data of the road side unit 10 by adopting such surveying tools as a theodolite and the like.

A storage module 102 for storing the accurate positioning data in a storage medium; and

after obtaining the accurate positioning data of the road side unit 10, the accurate positioning module 101 may transmit the accurate positioning data to the storage module 102, and the storage module 102 stores the accurate positioning data in the storage medium, for example, hardens and stores the accurate positioning data in a nonvolatile internal memory of the RSU.

A satellite positioning module 103 for obtaining satellite positioning data of the road side unit; and

the interior of the RSU may further include the satellite positioning module 103 for obtaining the satellite positioning data of the road side unit 10, the satellite positioning module 103 may adopt a positioning system, for example, GPS (Global Positioning System), GNSS (Global Navigation Satellite System), BDS (BeiDou Navigation Satellite System), GLONASS (Glonass navigation satellite System), etc. to obtain the satellite positioning data of the road side unit 10.

As the satellite positioning data are satellite positioning data obtained by the positioning system in real time, these data will be influenced by such factors as a satellite orbit error, an atmospheric delay error, a satellite clock error, a receiver clock error, a multipath error, an SA (frequent shake of a satellite clock, a manually introduced ephemeris error or the like) and the like, therefore the satellite positioning data are positioning data having errors.

A correction parameter determining module 104 for obtaining the accurate positioning data from the accurate positioning module, obtaining the satellite positioning data from the satellite positioning module, determining the differential positioning correction parameter according to the accurate positioning data and the satellite positioning data, and transmitting the differential positioning correction parameter to a sending module; and

the correction parameter determining module 104 may obtain the accurate positioning data from the accurate positioning module 101 or the storage module 102, obtain real-time satellite positioning data from the satellite positioning module 103, and then may determine the differential positioning correction parameter according to the accurate positioning data and the satellite positioning data.

In specific implementation, the differential positioning correction parameter may include a variety of types, for example, may include the following types:

1. Distance correction number

A calculation distance between station satellites may be calculated according to the accurate positioning data of the road side unit and satellite ephemeris, and an observation distance is subtracted from the calculation distance to obtain the distance correction number.

2. Position correction number (or called coordinate correction number)

A difference between the satellite positioning data and the accurate positioning data is calculated to obtain the position correction number.

3. Pseudo-range correction value

All visible GPS satellite pseudo-ranges within the visual field of the road side unit 10 are continuously tacked and are compared with a known distance to obtain the pseudo-range correction value.

4. Carrier phase parameter

The carrier phase parameter may include a carrier observation quantity and an accurate positioning parameter of the road side unit 10; or, the carrier phase parameter may include a carrier phase correction quantity calculated by the road side unit 10.

It should be noted that the types and calculation manners of the differential positioning correction parameter are merely examples of the embodiment of the present disclosure, those skilled in the art may determine the differential positioning correction parameter in other manners, and this is not necessarily limited in the embodiment of the present disclosure.

A sending module 105 for broadcasting the differential positioning correction parameter to the on board unit within the preset range.

Specifically, in the vehicle infrastructure cooperative system, the road side unit 10 may cover communication areas within the preset range, when a vehicle is driven into the communication area covered by the RSU, the OBU on the vehicle is wakened, at this time, a vehicle ad-hoc network (VANET) between the RSU and the OBU may be established, wherein the vehicle ad-hoc network is a novel multi-hop mobile wireless communication network, is composed of a vehicle equipped with the on board unit, the road side unit and a background network system, and transmits data through a wireless communication link (WAVE).

After the ad-hoc network between the RSU and the OBU is successful, the correction parameter determining module 104 is triggered by an event, the correction parameter determining module 104 sends the differential positioning correction parameter to the sending module 105 after obtaining the differential positioning correction parameter, and the sending module 105 broadcasts the differential positioning correction parameter to the on board unit in real time.

In a preferred embodiment of the embodiment of the present disclosure, the sending module 105 may further include the following sub-modules:

a package sub-module for packaging the differential positioning correction parameter into a dedicated short range communication DSRC short message; and

in the vehicle infrastructure cooperative system, the communication between the road side unit 10 and the on board unit 20 may be based on a DSRC (Dedicated Short Range Communications) technology to establish a microwave communication link therebetween. DSRC is an efficient wireless communication technology, and it may achieve identification and bidirectional communication on a moving target which moves at a high speed within a specific small area (tens of meters in general), for example, achieving “vehicle-road”, “vehicle-vehicle” bidirectional communication of vehicles, transmitting images, voice and data information in real time and organically connecting the vehicles with roads.

After receiving the differential positioning correction parameter, the sending module 105 may package the differential positioning correction parameter into the DSRC short message through the package sub-module and send the DSRC short message to a sending sub-module.

The sending sub-module is used for broadcasting the DSRC short message to the on board unit through a serve channel SCH in a WAVE protocol.

FCC (Federal Communications Commission) divides a DSRC frequency band into 7 independent channels with bandwidths of 10 MHz, including a control channel (abbreviated as CCH) and 6 serve channels (abbreviated as SCH), and meanwhile, it is regulated that the control channel is used for interaction of security applications and control information and the serve channels are used for loading non-security applications.

After receiving the DSRC short message, the sending sub-module may send and broadcast the DSRC short message to the wakened on board unit 20 through SCH. The SCH channel may be preferably a 176 channel (5880 Mhz).

Applied to the embodiment of the present disclosure, the road side unit 10 may further include:

a timing module for setting a periodic time for sending the differential positioning correction parameter and dispatching the correction parameter determining module 104 when reaching the periodic time.

After the correction parameter determining module 104 in the road side unit 10 is triggered by the event, in the embodiment of the present disclosure, the periodic time (e.g., 1 s) of sending the differential positioning correction parameter may be set by the timing module, and when reaching the periodic time, the correction parameter determining module 104 is periodically triggered to calculate the differential positioning correction parameter until the on board unit 20 departs from the communication area of the road side unit 10, or the communication between the on board unit 20 and the road side unit 10 is terminated.

The correction parameter determining module 104 periodically calculates the differential positioning correction parameter and sends the calculated differential positioning correction parameter to the sending module 105 in real time, and the sending module 105 sends the differential positioning correction parameter to the on board unit 20 in real time.

After receiving the differential positioning correction parameter, the on board unit 20 corrects the original positioning data received from the positioning system based on the differential positioning correction parameter to obtain the final positioning data of the on board unit.

For example, according to different types of the differential positioning correction parameter, the following correction process may be included: the position correction number or the distance correction number is eliminated from the original positioning data; the on board unit 20 tracks and observes the GPS satellite pseudo-ranges, corrects the corresponding GPS satellite pseudo-ranges according to the pseudo-range correction value sent by the road side unit 10 and positions the corrected pseudo-ranges; when the differential positioning correction parameter is the carrier observation quantity and the accurate positioning parameter, the on board unit 20 calculates a phase differential observation value according to a received carrier phase thereof and a carrier phase from the road side unit 10 and corrects the original positioning data according to the phase differential observation value; or, the on board unit directly corrects the original positioning data according to the carrier phase correction quantity sent by the road side unit 10.

Of course, the above-mentioned correction manner is merely an example of the embodiment of the present disclosure, other correction manners may be adopted in the field, and this is not necessarily limited in the embodiment of the present disclosure.

In the embodiment of the present disclosure, the road side unit in the intelligent vehicle infrastructure cooperative system is used as a base station to play the role of an application service provider, the on board unit is used as an mobile terminal to play the role of an application service user, DSRC in vehicle infrastructure cooperation is used as a communication technology, the road side unit is used for obtaining the differential positioning correction parameter and sending the differential positioning correction parameter to the on board unit, and the on board unit is used for correcting the original positioning data according to the differential positioning correction parameter to obtain the final positioning data of the on board unit, so as to achieve a differential positioning function in the vehicle infrastructure cooperative system, no additional base station needs to be deployed, no additional network access device needs to be added, mobile operators or the Internet is not utilized, the stability of the network state is guaranteed, and the device cost and the traffic cost are saved.

In addition, as the maximal communication distance between the road side unit and the on board unit is 300-1000 m, which is much smaller than the working range (40-50 km) of a traditional differential base station, the differential positioning accuracy of the embodiment of the present disclosure is much higher than that of traditional methods, and the positioning accuracy corrected by the on board unit may reach a sub-meter level or even a centimeter level.

Referring to FIG. 3, it shows a step flowchart of an embodiment of a differential positioning method based on an intelligent vehicle infrastructure cooperative system in an embodiment of the present disclosure, The intelligent vehicle infrastructure cooperative system includes a road side unit and an on board unit, and the method in the embodiment of the present disclosure may include the following steps:

step 301, obtaining a differential positioning correction parameter on the road side unit, and broadcasting the differential positioning correction parameter to the on board unit within a preset range; and

step 302, obtaining original positioning data of the on board unit on the on board unit, and correcting the original positioning data based on the differential positioning correction parameter to obtain final positioning data of the on board unit.

In a preferred embodiment of the embodiment of the present disclosure, the step 301 may further include the following sub-steps:

sub-step S11, obtaining accurate positioning data of the road side unit, wherein the accurate positioning data are positioning data having no error;

sub-step S12, obtaining satellite positioning data of the road side unit, wherein the satellite positioning data are positioning data having errors;

sub-step S13, determining the differential positioning correction parameter according to the accurate positioning data and the satellite positioning data; and

sub-step S14, broadcasting the differential positioning correction parameter to the on board unit within the preset range.

In a preferred embodiment of the embodiment of the present disclosure, the sub-step S14 may further include the following sub-steps:

sub-step S141, packaging the differential positioning correction parameter into a dedicated short range communication DSRC short message; and

sub-step S142, broadcasting the DSRC short message to the on board unit through a serve channel SCH in a WAVE protocol.

In a preferred embodiment of the embodiment of the present disclosure, the sub-step S13 may be as follows:

when reaching a preset periodic time for sending the differential positioning correction parameter, determining the differential positioning correction parameter according to the accurate positioning data and the satellite positioning data.

In a preferred embodiment of the embodiment of the present disclosure, the method may further include the following step:

storing the accurate positioning data in a storage medium.

Since the method embodiment as shown in FIG. 3 is basically the same as the system embodiment as shown in FIG. 1, it is relatively simply described, and for relevant parts, reference may be made to a part of illustrations in the embodiment shown in FIG. 1.

The present disclosure further provides an intelligent vehicle infrastructure cooperative system, comprising: a processor; and a memory for storing instructions executable by the processor; wherein the processor is configured to: obtain a differential positioning correction parameter and broadcasting the differential positioning correction parameter to an on board unit within a preset range; and obtain original positioning data of the on board unit, and correct the original positioning data based on the differential positioning correction parameter to obtain final positioning data of the on board unit.

The processor is further configured to: obtain accurate positioning data of the road side unit, wherein the accurate positioning data are positioning data having no error; obtain satellite positioning data of the road side unit, wherein the satellite positioning data are positioning data having errors; obtain the accurate positioning data from the accurate positioning module, obtain the satellite positioning data from the satellite positioning module, determine the differential positioning correction parameter according to the accurate positioning data and the satellite positioning data, and transmit the differential positioning correction parameter to a sending module; and broadcast the differential positioning correction parameter to the on board unit within the preset range.

The processor is further configured to: package the differential positioning correction parameter into a dedicated short range communication DSRC short message; and broadcast the DSRC short message to the on board unit through a serve channel SCH in a WAVE protocol.

The processor is further configured to: set a periodic time for sending the differential positioning correction parameter, and dispatch the correction parameter determining module when reaching the periodic time.

The processor is further configured to: store the accurate positioning data in a storage medium.

The embodiments of the intelligent vehicle infrastructure cooperative system described above are merely exemplary, wherein units described as separate components may be separate physically or not, components displayed as units may be or may not be physical units , namely, may be located in one place, or may also be distributed on a plurality of network units. A part of or all of the modules may be selected to achieve the objectives of the technical solutions in the embodiment according to actual needs. Those of ordinary skill in the art may understand and implement them without any creative effort.

By means of the above descriptions of the embodiments, those skilled in the art may clearly understand that the embodiments may be implemented by software plus a necessary universal hardware platform, and may also be implemented through by hardware. Based on this understanding, the above-mentioned technical solutions essentially or the part contributing to the prior art may be embodied in the form of a software product, the computer software product may be stored in a computer readable storage medium, such as a ROM/RAM, a magnetic disk, an optical disk or the like, and include several instructions for instructing a computer device (which may be a personal computer, a server, or a network device, etc.) to execute the method in the embodiments or certain portions of the embodiments.

Finally, it should be noted that the above-mentioned embodiments are merely used for illustrating rather than limiting the technical solutions of the present disclosure; although the present disclosure has been described in detail with reference to the foregoing embodiments, those of ordinary skill in the art should understand that they could still make modifications to the technical solutions recorded in the foregoing embodiments or make equivalent substitutions to a part of technical features; and these modifications or substitutions shall not make the essence of the corresponding technical solutions depart from the spirit and scope of the technical solutions of the embodiments of the present disclosure.

1. An intelligent vehicle infrastructure cooperative system, comprising:
a processor; and
a memory for storing instructions executable by the processor;
wherein the processor is configured to:
obtain a differential positioning correction parameter and broadcasting the differential positioning correction parameter to an on board unit within a preset range; and
obtain original positioning data of the on board unit, and correct the original positioning data based on the differential positioning correction parameter to obtain final positioning data of the on board unit.

2. The system of claim 1, the processor is further configured to:
obtain accurate positioning data of the road side unit, wherein the accurate positioning data are positioning data having no error;
obtain satellite positioning data of the road side unit, wherein the satellite positioning data are positioning data having errors;
obtain the accurate positioning data from the accurate positioning module, obtain the satellite positioning data from the satellite positioning module, determine the differential positioning correction parameter according to the accurate positioning data and the satellite positioning data, and transmit the differential positioning correction parameter to a sending module; and
broadcast the differential positioning correction parameter to the on board unit within the preset range.

3. The system of claim 2, the processor is further configured to:
package the differential positioning correction parameter into a dedicated short range communication DSRC short message; and
broadcast the DSRC short message to the on board unit through a serve channel SCH in a WAVE protocol.

4. The system of claim 2, the processor is further configured to:
set a periodic time for sending the differential positioning correction parameter, and dispatch the correction parameter determining module when reaching the periodic time.

5. The system of claim 2, the processor is further configured to:
store the accurate positioning data in a storage medium.

6. A differential positioning method based on an intelligent vehicle infrastructure cooperative system, wherein the intelligent vehicle infrastructure cooperative system comprises a road side unit and an on board unit, the method comprising:
obtaining a differential positioning correction parameter on the road side unit, and broadcasting the differential positioning correction parameter to the on board unit within a preset range; and
obtaining original positioning data of the on board unit on the on board unit, and correcting the original positioning data based on the differential positioning correction parameter to obtain final positioning data of the on board unit.

7. The method of claim 6, wherein the step of obtaining the differential positioning correction parameter on the road side unit, and broadcasting the differential positioning correction parameter to the on board unit within the preset range comprises:
obtaining accurate positioning data of the road side unit, wherein the accurate positioning data are positioning data having no error;
obtaining satellite positioning data of the road side unit, wherein the satellite positioning data are positioning data having errors;
determining the differential positioning correction parameter according to the accurate positioning data and the satellite positioning data; and
broadcasting the differential positioning correction parameter to the on board unit within the preset range.

8. The method of claim 7, wherein the step of broadcasting the differential positioning correction parameter to the on board unit within the preset range comprises:
packaging the differential positioning correction parameter into a dedicated short range communication DSRC short message; and
broadcasting the DSRC short message to the on board unit through a serve channel SCH in a WAVE protocol.

9. The method of claim 7, wherein the step of determining the differential positioning correction parameter according to the accurate positioning data and the satellite positioning data is as follows:
when reaching a preset periodic time for sending the differential positioning correction parameter, determining the differential positioning correction parameter according to the accurate positioning data and the satellite positioning data.

10. The method of claim 7, further comprising:
storing the accurate positioning data in a storage medium.

11. The system of claim 3, the processor is further configured to:
set a periodic time for sending the differential positioning correction parameter, and dispatch the correction parameter determining module when reaching the periodic time.

12. The system of claim 3, the processor is further configured to:
store the accurate positioning data in a storage medium.

13. The method of claim 8, wherein the step of determining the differential positioning correction parameter according to the accurate positioning data and the satellite positioning data is as follows:
when reaching a preset periodic time for sending the differential positioning correction parameter, determining the differential positioning correction parameter according to the accurate positioning data and the satellite positioning data.

14. The method of claim 8, further comprising:
storing the accurate positioning data in a storage medium.
